(19) United States
(12) Patent Application Publication
(10) Pub. No.: US 2020/0019024 A1
(43) Pub. Date: Jan. 16, 2020

(54) METHOD OF PRODUCING COLOR FILTER SUBSTRATE INCLUDING ALIGNMENT FILM AND METHOD OF PRODUCING LIQUID CRYSTAL PANEL

(71) Applicant: Sharp Kabushiki Kaisha, Sakai City (JP)

(72) Inventor: Kohshiroh TANIIKE, Sakai City (JP)

(21) Appl. No.: 16/507,089

(22) Filed: Jul. 10, 2019

Related U.S. Application Data
(60) Provisional application No. 62/822,196, filed on Mar. 22, 2019.
(60) Provisional application No. 62/696,866, filed on Jul. 12, 2018.

(51) Int. Cl. G02F 1/1337; G02F 1/1335; G02F 1/1339

(52) U.S. Cl. CPC G02F 1/133784; G02F 2201/123; G02F 1/13394; G02F 1/133516

(57) ABSTRACT

A method of producing a color filter substrate including an alignment film includes a color filter forming process, a photo spacer forming process, an alignment film forming process of forming an alignment film to cover the color filters and the photo spacer on the substrate, and a rubbing process of rubbing the alignment film sequentially with a first rubbing roller and a second rubbing roller having a columnar shape with a rotation shaft parallel to the substrate. The first rubbing roller is rotated in a direction to push back the substrate with respect to a forwarding direction of the substrate and the second rubbing roller is rotated in a direction to relatively push out the substrate, and second rubbing material on an outer periphery of the second rubbing roller has relatively lower bounce and resilience than those of first rubbing material on an outer periphery of the first rubbing roller.

### CROSS REFERENCE TO RELATED APPLICATION

This application claims priority from U.S. Provisional Application No. 62/696,866 filed on Jul. 12, 2018 and U.S. Provisional Application No. 62/822, 196 filed on March 22, 2019. The entire contents of the priority applications are incorporated herein by reference.

### TECHNICAL FIELD

The technology described herein relates to a method of producing a color filter substrate including an alignment film and a method of producing a liquid crystal panel.

### BACKGROUND

In a liquid crystal panel, a rubbing treatment of rubbing a surface of the polyimide alignment film disposed on the substrate with a cloth has been widely known as one of the methods of aligning liquid crystals regularly between a pair of substrates. Specifically, there has been widely known a technology of performing the rubbing treatment by rotating a roller having a rubbing cloth on a surface thereof and relatively moving the roller and the substrate having the alignment film thereon.

On a surface of the color filter substrate, which is one of the pair of substrates, a photo spacer that results in a large projection of micron unit is formed. Therefore, in rubbing the alignment film, the photo spacer may obstruct the rubbing treatment and the rubbing material is less likely to extend to some area. If the substrate has such an area having rubbing failures, unevenness is caused in an alignment regulation force that keeps an initial alignment state of the liquid crystals held between the pair of substrates included in the obtained liquid crystal panel. This may cause brightness unevenness and lower display quality in the liquid crystal panel.

If the rubbing treatment is performed with a great pressing amount to reduce the rubbing failures, an amount of foreign obstacles such as shavings of the alignment film or pile waste is increased. Further, alignment disorder or linear unevenness may be caused by pattern transfer of the color filter substrate. The amount increase of foreign obstacles, the alignment disorder, and occurrence of the linear unevenness may decrease the yield.

### SUMMARY

The technology described in this specification was made in view of the above circumstances. An object is to provide a method of producing a color filter substrate including an alignment film while achieving a uniform alignment regulation force without having unevenness and keeping good yield even with large unevenness thereon. Another technology described in this specification relates to a method of producing a liquid crystal panel that uses the color filter substrate produced with the above method of producing the color filter substrate including an alignment film while achieving a uniform alignment regulation force and good yield.

The technology disclosed in the present specification is related to a method of producing a color filter substrate including an alignment film including a color filter forming process of forming color filters on a substrate; a photo spacer forming process of forming a photo spacer on the substrate; an alignment film forming process of forming an alignment film to cover the color filters and the photo spacer formed on the substrate; and a rubbing process of rubbing the alignment film sequentially with a first rubbing roller and a second rubbing roller that have a columnar shape having a rotation shaft parallel to the substrate. The first rubbing roller is rotated in a direction so as to push back the substrate with respect to a relatively forwarding direction of the substrate and the second rubbing roller is rotated in a direction so as to relatively push out the substrate, and the first rubbing roller includes first rubbing material on an outer periphery thereof and the second rubbing roller includes second rubbing material on an outer periphery thereof and the second rubbing material has relatively lower bounce and resilience than those of the first rubbing material.

According to the method of producing a color filter substrate including an alignment film and a method of producing a liquid crystal panel described in this specification, a uniform alignment regulation force without having unevenness can be obtained and good yield can be achieved.

### BRIEF DESCRIPTION OF THE DRAWINGS

FIG. 1 is a schematic view illustrating a method of producing a color filter substrate including an alignment film according to one embodiment.

FIG. 2 is a schematic cross-sectional view illustrating a cross-sectional configuration of a liquid crystal panel.

FIG. 3 is a plan view schematically illustrating a structure of an array substrate.

FIG. 4 is a plan view schematically illustrating a structure of a color filter.

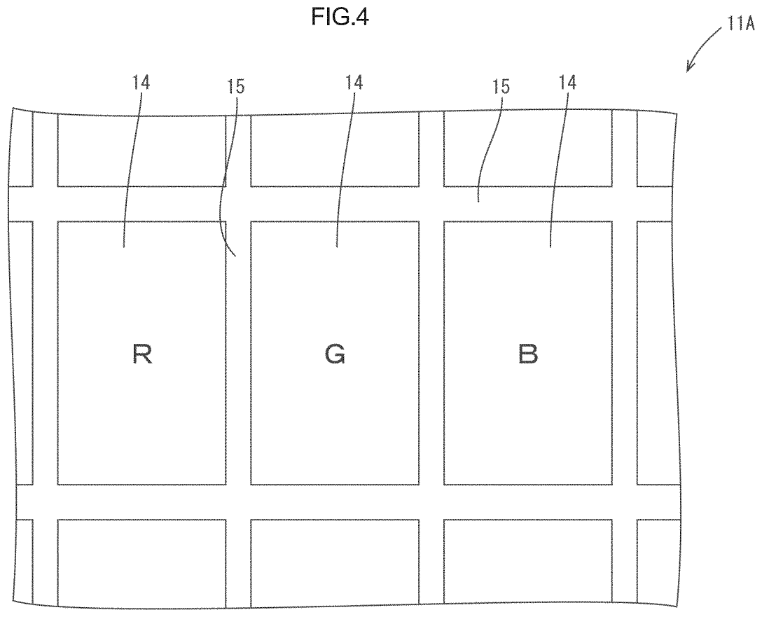

FIG. 5 is a schematic view illustrating a method of producing an array substrate including an alignment film.

### DETAILED DESCRIPTION

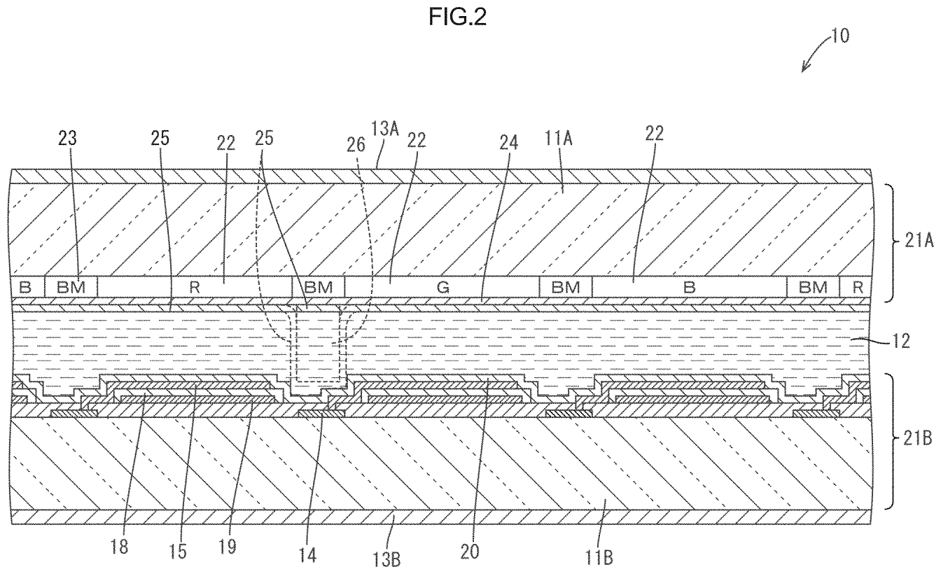

One embodiment will be described. A CF (color filter) substrate 21A including an alignment film that is formed with the producing method of the present embodiment is one of a pair of substrates included in a liquid crystal panel 10 having a known structure illustrated in FIG. 2. The CF substrate 21A including the alignment film corresponds to a CF substrate 11A including an alignment film 20 thereon that has been subjected to a rubbing treatment.

First, a liquid crystal panel 10 will be described. As illustrated in FIG. 2, the liquid crystal panel 10 includes a pair of substrates 11A, 11B and a liquid crystal layer (one example of liquid crystals) 12 that contains liquid crystal molecules and is arranged in an inner space between the substrates 11A, 11B. The liquid crystal molecules are substances that change optical properties thereof according to application of an electric filed (having dielectric anisotropy and orientation of the liquid crystal molecules are changed according to the application of an electric field). The liquid crystal layer 12 is surrounded by a sealing section that is between the substrates 11A, 11B and sealed therewith. Of the pair of the substrates 11A, 11B, the front side is a CF substrate (one example of a counter substrate) 11A and the back side is an array substrate 11B. Each of the CF substrate 11A and the array substrate 11B is formed by stacking various kinds of films on an inner surface side of a glass substrate. Polarizing plates 13A, 13B are bonded on outer surfaces of the substrates 11A, 11B, respectively.

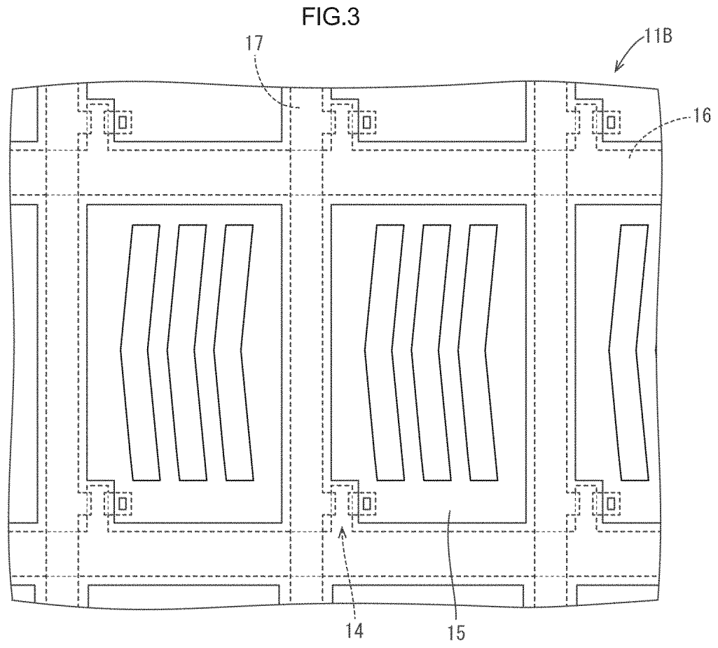

As illustrated in FIGS. 2 and 3, on the array substrate 11B, thin film transistors (TFTs) 14, which are switching components, and pixel electrodes 15 are arranged in a matrix and gate lines 16 and source lines 17 are arranged in a grid to surround the TFTs 14 and the pixel electrodes 15. Predetermined image signals are supplied from a control circuit to each of the lines. The pixel electrodes 15 are formed from transparent electrode material such as indium tin oxide (ITO), zinc oxide (ZnO), indium zinc oxide (IZO), or indium gallium zinc oxide (IGZO). The pixel electrodes 15 create a level difference of about 30 nm to 80 nm on the array substrate 11B.

A common electrode 19 that is formed from the transparent electrode film similarly to the pixel electrodes 15 is disposed below the pixel electrode 15 while having an insulation layer 18 therebetween. Thus, the pixel electrode 15 and the common electrode 19 are formed on the array substrate 11B. If a potential difference is created between the electrodes 15, 19, a fringe electric field including a component in a direction normal to a plate surface of the array substrate 11B is applied to the liquid crystal layer 12 in addition to a component in a direction along the plate surface of the array substrate 11B. The liquid crystal panel 10 operates in a fringe field switching (FFS) mode that is a mode improved from an in-plane switching (IPS) mode.

An alignment film 20 (one example of an opposite side alignment film) such as a polyimide film is disposed on an upper surface of the array substrate 11B to cover the TFTs 14 and the pixel electrodes 15.

As illustrated in FIG. 2, the CF substrate 11A includes color filters 22 so as to be opposite the respective pixel electrodes 15 included in the array substrate 11B. The color filters 22 include color portions in three colors of red (R), green (G), and blue (B) arranged repeatedly in a matrix. Each of the color portions (each pixel) of the color filters arranged in a matrix is defined by a light blocking section (a black matrix) 23 and the light blocking section 23 prevents color light rays passing through the color portions from being mixed. An overcoat film 24 is disposed on inner surfaces of the color filters 22 and the light blocking section 23. Columnar photo spacers (PS) 26 are arranged on the light blocking section 23 at a certain density and at certain intervals to keep a gap between the array substrate 11B and the overcoat film 24 for holding the liquid crystal layer 12 therebetween. An alignment film 25 is disposed on inner surfaces of the overcoat film 24 and the photo spacers 26.

Since the array substrate 11B of the pair of substrates includes the pixel electrode 15 thereon, a high alignment regulation force that keeps an initial alignment state of the liquid crystals held between the pair of substrates 11A, 11B is required. The CF substrate 11A that does not include any pixel electrode thereon needs only about a half of the alignment regulation force of the array substrate 11B. The CF substrate 11A has relatively great projections of about 3 μm that are created by the photo spacers 26, as described before. Therefore, the CF substrate 11A may have sections where the rubbing material is less likely to reach sufficiently in the rubbing treatment due to the shadows of the photo spacers 26. Such sections may cause display unevenness in the liquid crystal panel 10. The present embodiment is related to an optimal method of producing the CF substrate 21A including an alignment film to solve such specific problems in the CF substrate 11A.

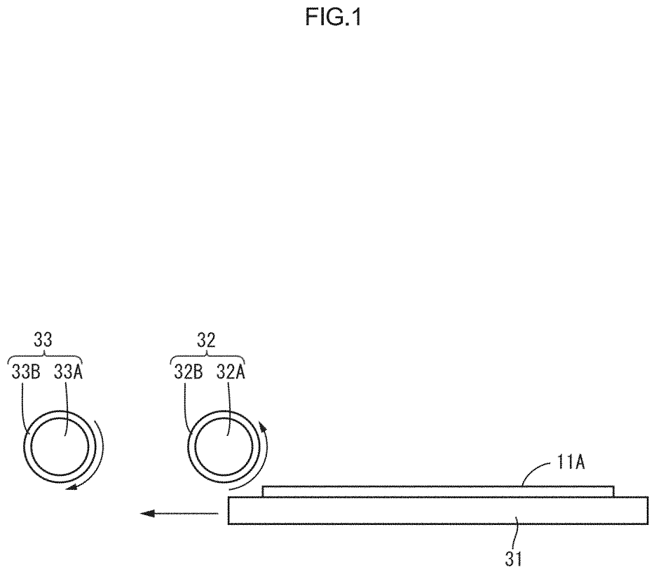

Next, a method of producing the CF substrate 21A including an alignment film will be described. FIG. 1 is a schematic view illustrating an alignment treatment method (a rubbing process) for the CF substrate 11A having the alignment film 25 thereon according to one embodiment. First, color filters (CF) 22 and the photo spacers (PS) 26 are formed on a substrate (a color filter forming process and a photo spacer forming process) and the alignment film 25 is formed to cover the CFs 22 and the PSs 26 (an alignment film forming process). The CF substrate 11A having the alignment film 25 thereon is held with being sucked on a stage 31 of a transfer device included in a rubbing device in a horizontal state. The feeding speed (stage moving speed) of the stage 31 can be changed, and the rotational speed of rubbing rollers 32, 33, which will be described later, and the number of rubbing times of rubbing the alignment film 25 can be adjusted. In the present embodiment, the stage 31 can move in only one direction (from right to left in FIG. 1).

The rubbing device includes a pair of rotatable rubbing rollers 32, 33 above a transfer path of the stage 31. One of the rubbing rollers 32, 33 is a first rubbing roller 32 disposed on an upstream side in the transfer direction and another one is a second rubbing roller 33 disposed on a downstream side in the transfer direction from the first rubbing roller 32. The first rubbing roller 32 and the second rubbing roller 33 have a columnar shape and a rotation shaft thereof is parallel to the CF substrate 11A and perpendicular to the transfer direction. The first rubbing roller 32 and the second rubbing roller 33 have a same length and a same diameter.

The first rubbing roller 32 includes a first roller 32A having a columnar shape and a cloth (one example of first rubbing material) 32B made of cotton. An outer surface of the first roller 32A is wrapped with the cloth 32B. The second rubbing roller 33 includes a second roller 33A having a columnar shape and a cloth (one example of second rubbing material) 33B made of rayon. An outer surface of the second roller 33A is wrapped with the cloth 33B. Accordingly, the surface of the second rubbing roller 33 has lower bounce and resilience than the surface of the first rubbing roller 32.

The rubbing material 32B, 33B of the first rubbing roller 32 and the second rubbing roller 33 may not be limited to cotton and rayon but maybe desired rubbing material. The rotation direction, the rotational speed, and a level position with respect to the CF substrate 11A (the stage 31) may be determined independently for each of the first rubbing roller 32 and the second rubbing roller 33. The rotational speed is defined by the number of rotation times of the rubbing roller 32, 33 per unit time (rpm/revolutions per minute). The position level of the rubbing rollers 32, 33 adjusts a pressing amount (a contact amount) by which the rubbing material 32B, 33B of each of the rubbing rollers 32, 33 is contacted with the CF substrate 11A. Furthermore, the position level of the rubbing rollers 32, 33 can be set such that one of the rubbing rollers 32, 33 is contacted with the CF substrate 11A and another one is away from the CF substrate 11A and one of the rubbing materials 32B, 33B wrapped around the rollers is not contacted with the CF substrate 11A.

If the CF substrate 11A including the alignment film 25 on the surface thereof is transferred in the transfer direction (from the right to the left in FIG. 1) by the transfer device, the first rubbing roller 32 and the second rubbing roller 33 are rotated and in contact with the surface of the alignment film 25 sequentially and the rubbing treatment is performed (the rubbing process). In the process, the first rubbing roller 32 is rotated in a direction so as to push back the CF substrate 11A (rotated in a counterclockwise direction in FIG. 1, hereinafter, the rubbing treatment with the rotation in the direction is referred to as upper rubbing) with respect to a forwarding direction (the transfer direction) of the CF substrate 11A. The second rubbing roller 33 is rotated in a direction so as to push out the CF substrate 11A (rotated in a clockwise direction in FIG. 1, hereinafter, the rubbing treatment with the rotation in the direction is referred to as down rubbing).

Thus, the CF substrate 11A having the CFs 22, the PSs 26, and the alignment film 25 covering them is subjected to the rubbing treatment with the first rubbing roller 32 that has relatively high bounce and resilience in the surface to create an effective alignment regulation force that is appropriate for the CF substrate 11A in a large area of the CF substrate 11A. In the rubbing treatment, shadows of PSs 26 may occur and the first rubbing roller 32 may not reach some area of the substrate due to the PSs 26 having great height and such sections may have rubbing failures. However, in the present embodiment, the rubbing treatment is performed subsequently by the second rubbing roller 33 that is soft and has relatively low bounce and resilience in the surface such that the second rubbing roller 33 reaches the sections where the rubbing failures are caused in the rubbing treatment with the first rubbing roller 32. Accordingly, the CF substrate 21A including the alignment film that is almost uniform and has less unevenness as a whole is obtained.

In the process, the first rubbing roller 32 is rotated with the upper rubbing and the second rubbing roller 33 is rotated with the down rubbing such that the rotation directions thereof are opposite from each other. Accordingly, the rubbing rollers are likely to reach the shadows of the PSs 26 having great height compared to a case in that the rotation directions thereof are same.

As described before, the material having relatively lower bounce and resilience is used as the second rubbing material 33B of the second rubbing roller 33 such that the foreign obstacles created by rubbing with the first rubbing roller 32 can be effectively removed. Such an effect of removing the foreign obstacles is exerted greatly in the down rubbing than in the upper rubbing. Therefore, the second rubbing roller 33 is preferably rotated with the down rubbing and the first rubbing roller 32 is preferably rotated with the upper rubbing. According to such a method of producing the CF substrate 21A including an alignment film according to the present embodiment, a uniform alignment regulation force without having unevenness as a whole can be obtained and the yield can be improved.

If the pair of rubbing rollers are rotated in the opposite directions, the rubbing failures caused by the great projections can be prevented but the rubbing effects of the respective rubbing rollers being cancelled. Therefore, the alignment regulation force (represented by retardation of the alignment film) generally tends to be lowered. Regarding such a problem, according to the present embodiment, the rubbing treatments in the opposite rotation directions are performed with changing the material of the first rubbing material 32B and the second rubbing material 33B and utilizing difference of the bounce and resilience of the rubbing material itself. Compared to the rubbing treatment with using the same material for the first rubbing material 32B and the second rubbing material 33B, it was confirmed that the effects of cancelling the rubbing effects were halved in the present embodiment. Accordingly, the CF substrate 11A has better alignment regulation force while suppressing the rubbing failures caused by the shadows of the PSs 26.

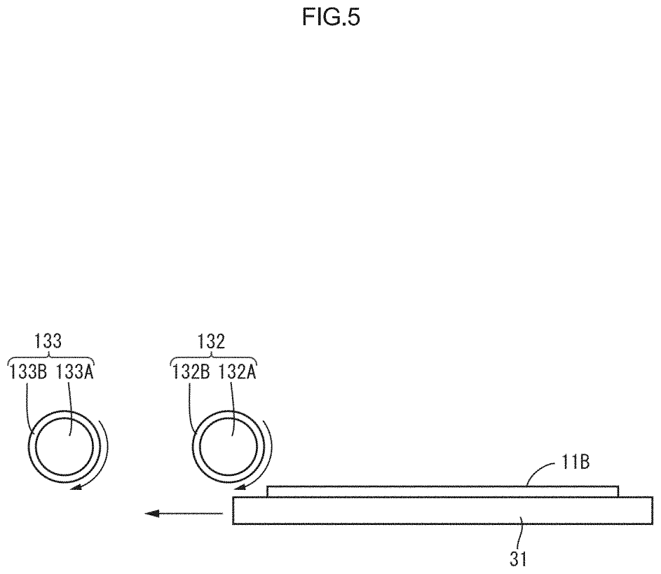

The array substrate 11B including the alignment film 20 that is used in the present embodiment is subjected to the rubbing treatment (an opposite side rubbing process) by a rubbing device including a first rubbing roller 132 (one example of an opposite side first rubbing roller) and a second rubbing roller 133 (one example of an opposite side second rubbing roller) similarly to the above-described rubbing device for the CF substrate 11A. The first rubbing roller 132 includes a columnar first roller 132A and first rubbing material 132B (one example of opposite side first rubbing material) having relatively high bounce and resilience on an outer periphery thereof. The second rubbing roller 133 includes a columnar second roller 133A and second rubbing material 133B (one example of opposite side second rubbing material) having relatively low bounce and resilience on an outer periphery thereof. Unlike the rubbing device for the CF substrate 11A, the first rubbing roller 132 and the second rubbing roller 133 are both rotated with the down rubbing (see FIG. 5).

The array substrate 11B having the pixel electrodes 15 thereon is required to have a high alignment regulation force (retardation of the alignment film) unlike the CF substrate 11A. The array substrate 11B has a level difference of about 30 nm to 80 nm on a surface thereof due to the pixel electrodes 15. Such a level difference is smaller than that created by the PSs 26 of the CF substrate 11A, which is about 3 μm. On the other hand, the array substrate 11B has a complicated uneven surface unlike the CF substrate 11A and therefore, the rubbing material may not reach an entire area of the uneven surface and a high alignment regulation force is less likely to be obtained.

Regarding such a problem, in the present embodiment, in producing the array substrate 11B, the first rubbing roller 132 having relatively high bounce and resilience in the surface and the second rubbing roller 133 having relatively low bounce and resilience in the surface are used in combination in the rubbing process and the first rubbing roller 132 and the second rubbing roller 133 are rotated with the down rubbing. According to such a configuration, a high alignment regulation force that is required for alignment for a large area is obtained by the first rubbing roller 132 and subsequently the rubbing treatment is performed by the second rubbing roller 133 for an entire area of the complicated uneven surface that has not been rubbed by the first rubbing roller 132. Thus, the alignment regulation force is obtained. At the same time, the foreign obstacles created by the rubbing with the first rubbing roller 132 are removed by the second rubbing roller 133 having low bounce and resilience in the surface. Therefore, a high alignment force regulation force with less unevenness is obtained in the array substrate 11B as a whole and the yield is improved.

The first rubbing roller 132 having relatively high bounce and resilience in the surface and the second rubbing roller 133 having relatively low bounce and resilience in the surface are used in combination and the rotation directions thereof are the down rubbing such that the synergetic effects are obtained regarding the alignment treatment and the high alignment regulation force can be exerted. Specifically, the first rubbing roller 132 and the second rubbing roller 133 are used for the rubbing of the array substrate 11B most preferably in combination such that retardation (Δnd2) of the array substrate 11B that is rubbed by a single roller of the second rubbing roller 133 is in a range from 50% to 60% of retardation (Δnd1) of the array substrate 11B that is rubbed by a single roller of the first rubbing roller 132 (Δnd2/Δnd1×100=50 to 60 (%)). With such a combination, the retardation (Δnd) that is equal to or greater than the total value (Δnd1+Δnd2) of the retardation by the rubbing rollers 132, 133 can be obtained most effectively.

After the rubbing process, the obtained CF substrate 21A including the alignment film and the obtained array substrate 21B including the alignment film are arranged such that the alignment films are opposite each other and the liquid crystals (the liquid crystal layer 12) are enclosed between the alignment films 20, 25 and sealed with sealing material. Thus, the liquid crystal panel 10 holding the liquid crystals (the liquid crystal layer 12) between the pair of substrates 21A, 21B is produced (the liquid crystal holding process).

The liquid crystal panel 10 produced as described before has a uniform and high alignment regulation force without having unevenness and has high yield.

Next, Examples in which the producing method of the embodiment is specifically carried out and Comparative Examples will be described in detail.

1. Verification of a CF substrate including an alignment film and a dummy substrate including an alignment film that are subjected to a rubbing treatment with using a single rubbing roller, and a liquid crystal panel.

Prior to Examples, the CF substrate including an alignment film and the dummy substrate including an alignment film that are subjected to the rubbing treatment with using a single rubbing roller, and the liquid crystal panel including the CF substrate including the alignment film were evaluated with a method described below.

First, the CF substrate 11A on which the color filters (CF) 22 and the photo spacers (PS) 26 are formed (the color filter forming process and the photo spacer forming process) and the dummy substrate without having such patterns were obtained. On each of the CF substrate 11A and the dummy substrate, a polyimide film having film thickness of about 100 nm was formed with flexographic printing method (the alignment film forming process). Each of the substrates including films was placed on the stage 31 of the transfer device at a certain position and held with being sucked. Then, each of the CF substrate including a film and the dummy substrate including a film were transferred at a speed of 20 mm/sec and subjected to the rubbing treatment by a single rubbing roller including a roller of a 150 mm φ diameter and rubbing material wrapped around the roller under the conditions illustrated in Table 1 . A liquid crystal panel was produced with using the CF substrate including the alignment film obtained with the rubbing treatment and the array substrate including the alignment film produced under the conditions illustrated in Table 2.

For each CF substrate including the alignment film and the liquid crystal panel thus obtained, frequencies of occurrence of unevenness were observed. The frequency of occurrence of unevenness was observed by supplying steam to the alignment treatment surface of the CF substrate including the alignment film and visually checking the unevenness with using a halogen lamp and a green lamp. The frequency of occurrence of unevenness was observed by arranging two polarizing plates of crossed Nicols on outer surfaces of the liquid crystal panel and checking alignment on the backlight. In such an alignment test, if the rubbing material does not reach an entire area of the shadows of the PSs 26 effectively and light is not blocked by the section corresponding to the light blocking section 23 and reaches the active area of the liquid crystal panel, the light is recognized as light leaking and the checking is made easily. The results of the unevenness illustrated in Table are evaluation results of the CF substrate including the alignment film and the liquid crystal panel. Further, the frequency of generation of dust was observed by counting the number of foreign obstacles on the CF substrate including the alignment film with using a foreign obstacle checker produced by KUBOTECH Corp.

The retardation (Δnd) that is an index of the alignment regulation force was measured for each of the dummy substrates including alignment films. “AxoScan FAA-3 series” produced by Axometrics, Inc. was used for the measurement. Light is supplied to the alignment processed surface of the dummy substrate including an alignment film from an upper side thereof and the retardation of transmitted light rays was measured. The retardation was measured at twelve points within the alignment film surface area and average, standard deviation, and standard deviation/average were calculated. The retardation of the dummy substrate including an alignment film is measured since the light rays for measurement may be reflected irregularly by the uneven pattern such as the CFs or the PSs and correct measurement values of the alignment film may not be obtained if the measurement is performed for the CF substrate including an alignment film.

The production conditions and the measurement results of each sample are illustrated in Table 1.

TABLE 1

| | | | ROTATIONAL | CONTACT | | |
|---|---|---|---|---|---|---|
| | RUBBING | ROTATION | SPEED | AMOUNT | | |
| | CLOTH | DIRECTION | [rpm] | [mm] | UNEVENNESS | DUST |
| COMPARATIVE EXAMPLE 1 | COTTON | UPPER | 450 | 0.25 | X | Δ |
| COMPARATIVE EXAMPLE 2 | COTTON | UPPER | 450 | 0.45 | Δ | X |
| COMPARATIVE EXAMPLE 3 | COTTON | DOWN | 650 | 0.3 | X | ◯ |
| COMPARATIVE EXAMPLE 4 | COTTON | DOWN | 650 | 0.5 | Δ | Δ |
| COMPARATIVE EXAMPLE 5 | RAYON | DOWN | 1200 | 0.25 | Δ | ⊚ |
| COMPARATIVE EXAMPLE 6 | RAYON | DOWN | 1200 | 0.35 | Δ | ◯ |

| | RETARDATION [Δnd] | | |
|---|---|---|---|
| | | STANDARD | STANDARD DEVIATION/ |
| | AVERAGE | DEVIATION | AVERAGE |
| COMPARATIVE EXAMPLE 1 | 0.1940 | 0.0788 | 41% |
| COMPARATIVE EXAMPLE 2 | 0.2063 | 0.0358 | 17% |
| COMPARATIVE EXAMPLE 3 | 0.2561 | 0.1102 | 43% |
| COMPARATIVE EXAMPLE 4 | 0.3055 | 0.0894 | 29% |
| COMPARATIVE EXAMPLE 5 | 0.2831 | 0.1141 | 40% |
| COMPARATIVE EXAMPLE 6 | 0.2713 | 0.1382 | 51% |

⊚ QUITE LESS
◯ LESS
Δ A FEW
X MUCH

Further, Table 2 shows the production conditions and the measurement results of the array substrate used in the present embodiment.

TABLE 2

| | FIRST RUBBING ROLLER | | | | |
|---|---|---|---|---|---|
| | | | ROTATIONAL | CONTACT | RETARDATION |
| | RUBBING | ROTATION | SPEED | AMOUNT | AVERAGE |
| | CLOTH | DIRECTION | [rpm] | [mm] | Δnd1 |
| ARRAY SUBSTRATE | COTTON | DOWN | 1000 | 0.7 | 0.4304 |

| | SECOND RUBBING ROLLER | | | | | |
|---|---|---|---|---|---|---|
| | | | ROTATIONAL | CONTACT | RETARDATION | |
| | RUBBING | ROTATION | SPEED | AMOUNT | AVERAGE | SECOND/ |
| | CLOTH | DIRECTION | [rpm] | [mm] | Δnd2 | FIRST (*) |
| ARRAY SUBSTRATE | RAYON | DOWN | 1200 | 0.4 | 0.2237 | 52% |

| | TWO RUBBING ROLLERS | | | | |
|---|---|---|---|---|---|
| | RETARDATION [Δnd] | | | DUST | |
| | | STANDARD | STANDARD DEVIATION/ | AND | |
| | AVERAGE | DEVIATION | AVERAGE | UNEVENNESS | α (**) |
| ARRAY SUBSTRATE | 0.7700 | 0.1823 | 24% | ⊚ | 0.11593 |

(*) (RETARDATION BY SECOND ROLLER/RETARDATION BY FIRST ROLLER) × 100
(**) α = (RETARDATION BY TWO ROLLERS) − (RETARDATION BY FIRST ROLLER + RETARDATION BY SECOND ROLLER)
⊚ QUITE LESS

As illustrated in Table 1, in comparing Comparative Example 1 and Comparative Example 2 in which cotton was used as the rubbing material and the upper rubbing was performed at the rotational speed of 450 rpm, more unevenness is caused in Comparative Example 1 in which the contact amount is low (the pressing amount is small) and more generation of dust is caused in Comparative example 2 in which the contact amount is great. Regarding the retardation, the average is slightly better in Comparative Example 2 than in Comparative Example 1 and variation of the retardation (standard deviation/average) of Comparative Example 2 was less than half of that of Comparative Example 1 or less, which is small.

In comparing Comparative Example 3 and Comparative Example 4 in which cotton was used as the rubbing material and the down rubbing was performed at the rotational speed of 650 rpm, more unevenness is caused in Comparative Example 3 in which the contact amount is low and unevenness was slightly improved and more generation of dust is caused in Comparative example 4 in which the contact amount is great. Regarding the retardation, the average is better in Comparative Example 4 than in Comparative Example 3 and variation of the retardation (standard deviation/average) was smaller in Comparative Example 4 than in Comparative Example 3. That is, the same tendency as that of Comparative Example 1 and Comparative Example 2 was observed.

In comparing Comparative Example 5 and Comparative Example 6 in which rayon having relatively lower bounce and lower resilience than those of cotton was used as the rubbing material and the down rubbing was performed at the rotational speed of 1200 rpm, the same tendency was observed. That is, the generation of dust was less in Comparative Example 5 with the smaller contact amount than in Comparative Example 6 with the greater contact amount. Unevenness was almost same. The unevenness and the generation of dust using rayon as the rubbing material were better than those using cotton as the rubbing material. On the other hand, regarding the retardation, the average and variation were better in the substrate with the smaller contact amount and the results using rayon are opposite from those using cotton.

2. Evaluation of a CF substrate including an alignment film, a dummy substrate including an alignment film and a liquid crystal panel that are subjected to a rubbing treatment with using two rubbing rollers.

Based on the results of the rubbing treatment with using a single rubbing roller illustrated in Table 1, the evaluation was made for the CF substrate 21A including an alignment film and the dummy substrate including an alignment film that are subjected to the rubbing treatment (the rubbing process) with using the two rubbing rollers 32, 33 under the conditions of Table 3 and for the liquid crystal panel 10 including the CF substrate 21A including the alignment film. The method of forming the substrate including a film performed before the rubbing treatment and the method of producing the liquid crystal panel (and the array substrate including the alignment film that is used) is same as that of above 1, and the transfer speed is 20 mm/sec similarly to the above 1. The measurement method is same as that of the above 1.

The production conditions of each sample and the measurement results are illustrated in Table 3.

TABLE 3

| | FIRST RUBBING ROLLER | | | | |
|---|---|---|---|---|---|
| | | | ROTATIONAL | CONTACT | RETARDATION |
| | RUBBING | ROTATION | SPEED | AMOUNT | AVERAGE |
| | CLOTH | DIRECTION | [rpm] | [mm] | [Δnd1] |
| COMPARATIVE EXAMPLE 7 | COTTON | UPPER | 450 | 0.25 | 0.1940 |
| COMPARATIVE EXAMPLE 8 | COTTON | UPPER | 450 | 0.45 | 0.2063 |
| EXAMPLE 1 | COTTON | UPPER | 450 | 0.45 | 0.2063 |

| | SECOND RUBBING ROLLER | | | | | | |
|---|---|---|---|---|---|---|---|
| | | | ROTATIONAL | CONTACT | RETARDATION | | |
| | RUBBING | ROTATION | SPEED | AMOUNT | AVERAGE | | |
| | CLOTH | DIRECTION | [rpm] | [mm] | [Δnd2] | UNEVENNESS | DUST |
| COMPARATIVE | COTTON | DOWN | 650 | 0.3 | 0.2561 | ◯ | Δ |
| EXAMPLE 7 | | | | | | | |
| COMPARATIVE | COTTON | DOWN | 650 | 0.5 | 0.3055 | ◯ | X |
| EXAMPLE 8 | | | | | | | |
| EXAMPLE 1 | RAYON | DOWN | 1200 | 0.25 | 0.2831 | ⊚ | ⊚ |

| | TWO RUBBING ROLLERS | | |
|---|---|---|---|
| | RETARDATION [Δnd] | | |
| | | STANDARD | STANDARD DEVIATION/ |
| | AVERAGE | DEVIATION | AVERAGE |
| COMPARATIVE EXAMPLE 7 | 0.1746 | 0.0549 | 31% |
| COMPARATIVE EXAMPLE 8 | 0.2989 | 0.1346 | 45% |
| EXAMPLE 1 | 0.3848 | 0.1332 | 35% |

NOTE:
SUPERIORITY OF UNEVENNESS IS (BETTER) COMPARATIVE EXAMPLE 8 > COMPARATIVE EXAMPLE 7 (WORSE)
⊚ QUITE LESS
◯ LESS
Δ A FEW
X MUCH

As illustrated in Table 3, if the rotation direction of the first rubbing roller 32 is the upper rubbing and that of the second rubbing roller 33 is the down rubbing, the portions corresponding to the shadows of the PSs 26 that are less likely to be rubbed are hardly created even with the PS (photo spacers) 26, and the unevenness is less likely to be caused (see Comparative Example 7, Comparative Example 8, Example 1).

In comparative Example 7 and Comparative Example 8, in which cotton was used as the first rubbing material 32B and the second rubbing material 33B, the generation of dust was much and the yield was poor. The measurement values of the retardation after the rubbing treatment with the two rubbing rollers were smaller than those obtained with using each of the rubbing rollers as a single roller. Such a result may be obtained because the rubbing effects were cancelled by rotating the rubbing rollers 32, 33 in the opposite direction.

Contrary to Comparative Example 7 and Comparative Example 8 as described before, in Example 1, cotton having relatively high bounce and resilience was used as the first rubbing material 32B, and subsequently, rayon having relatively low bounce and resilience was used as the second rubbing material 33B, and the unevenness was further improved. The rubbing failures caused by the PSs 26 are improved since the bounce and resilience of the rubbing material are also changed by using different kinds of materials for the first rubbing material 32B and the second rubbing material 33B in addition to changing of the rotation directions of the first rubbing roller 32 and the second rubbing roller 33.

Further, rayon was used as the second rubbing material 33B such that the foreign obstacles such as shavings or pile waste created by the first rubbing roller 32 were removed by the rayon having low bounce and resilience like a broom. Therefore, the generation of dust was greatly improved.

In Example 1, the retardation (the average) was higher than each retardation (Δnd1 or Δnd2) obtained by using the first rubbing roller 32 or the second rubbing roller 33 as a single roller. The rubbing power changed with utilizing bounce and resilience of the rubbing material itself by changing the material kind of the first rubbing material 32B and the second rubbing material 33B. Accordingly, the effects of cancelling the rubbing effects with the opposite rotations were halved in Example.

According to the results described before, it was confirmed that the rubbing failure of the CF substrate 11A due to the projections of the PSs 26 was improved and uniform retardation with less unevenness was obtained and generation of dust was less if the rubbing treatment was performed with cotton having relatively high bounce and resilience and subsequently the rubbing treatment is performed with rayon having relatively low bounce and resilience.

<Other Embodiments>

The present technology is not limited to the embodiments described in the above sections and the drawings. For example, the following embodiments may be included in the technical scope.

(1) In the above embodiment, the transfer direction of the substrate relative to the first rubbing rollers 32, 132 and the second rubbing rollers 33, 133 is one direction and one pair of rubbing rollers are contacted with the substrate from the same direction; however, the substrate may be moved in a reciprocating way with respect to one pair of rubbing rollers to perform a rubbing treatment. Such a method may lower a tact.

(2) In the above embodiment, the first rubbing roller 32, 132 and the second rubbing roller 33, 133 have a same diameter but may have different diameters.

(3) In the above embodiment, the rotation shaft of each of the first rubbing roller 32, 132 and the second rubbing roller 33, 133 is orthogonal to the transfer direction but may not be orthogonal to the transfer direction.

(4) The pressing amount or the rotational speed of each rubbing roller is not limited to those in the above embodiment but may be altered as appropriate. The transfer speed of the transfer device is not limited to those in the above embodiment.

(5) The array substrate including an alignment film used in the liquid crystal panel is not limited to that in the above embodiment. An array substrate produced under different producing conditions may be used.

1. A method of producing a color filter substrate including an alignment film comprising:
a color filter forming process of forming color filters on a substrate;
a photo spacer forming process of forming a photo spacer on the substrate;
an alignment film forming process of forming an alignment film to cover the color filters and the photo spacer formed on the substrate; and
a rubbing process of rubbing the alignment film sequentially with a first rubbing roller and a second rubbing roller that have a columnar shape having a rotation shaft parallel to the substrate, wherein
the first rubbing roller is rotated in a direction so as to push back the substrate with respect to a relatively forwarding direction of the substrate and the second rubbing roller is rotated in a direction so as to relatively push out the substrate, and the first rubbing roller includes first rubbing material on an outer periphery thereof and the second rubbing roller includes second rubbing material on an outer periphery thereof and the second rubbing material has relatively lower bounce and resilience than those of the first rubbing material.

2. The method of producing a color filter substrate including an alignment film according to claim 1, wherein the first rubbing material is cotton and the second rubbing material is rayon.

3. A method of producing a liquid crystal panel comprising:
a liquid crystal holding process of holding liquid crystals between the color filter substrate including an alignment film that is produced with the producing method according to claim 1 and a counter substrate including an alignment film that is disposed opposite the alignment film of the color filter substrate including the alignment film, the counter substrate including an opposite side alignment film on a surface thereof opposite the color filter substrate including the alignment film.

4. The method of producing a liquid crystal panel according to claim 3, wherein
the counter substrate including the alignment film includes the opposite side alignment film on an array substrate including TFTs and a pixel electrode on the substrate and is subjected to at least an opposite side rubbing process in which a rubbing treatment is performed sequentially with an opposite side first rubbing roller and an opposite side second rubbing roller that have a columnar shape having a rotational shaft parallel to the array substrate,
the opposite side first rubbing roller includes opposite side first rubbing material on an outer periphery thereof and the opposite side second rubbing roller includes opposite side second rubbing material on an outer periphery thereof and the opposite side first rubbing material has relatively higher bounce and resilience than those of the opposite side second rubbing material, and
the opposite side first rubbing roller and the opposite side second rubbing roller are rotated in a direction so as to push out the array substrate in a relatively forwarding direction of the array substrate.

5. The method of producing a liquid crystal panel according to claim 4, wherein the opposite side first rubbing roller and the opposite side second rubbing roller are used in combination such that retardation (Δnd2) of the substrate that is rubbed by a single roller of the opposite side second rubbing roller is in a range from 50% to 60% of retardation (Δnd1) of the substrate that is rubbed by a single roller of the opposite side first rubbing roller.
